(19) United States
(12) Patent Application Publication
(10) Pub. No.: US 2016/0144521 A1
(43) Pub. Date: May 26, 2016

(54) FOOD CUTTING APPARATUS

(71) Applicant: Columbia Insurance Company, Omaha, NE (US)

(72) Inventors: E. MARK HARRIS, MCHENRY, IL (US); ROLAND SUDMALIS, PARK RIDGE, IL (US)

(21) Appl. No.: 14/947,457

(22) Filed: Nov. 20, 2015

Related U.S. Application Data
(60) Provisional application No. 62/085,139, filed on Nov. 26, 2014.

(51) Int. Cl. B26B 29/06

(52) U.S. Cl. CPC B26B 29/063

(57) ABSTRACT

A food cutting apparatus has an upper plate housing connected to a lower plate housing and capable of being moved from an open position to a closed position where the upper plate housing is adjacent to the lower plate housing. The lower plate housing includes a base capable of being supported on a flat surface. A floating upper plate is disposed in the upper plate housing and the upper plate is capable of moving within the upper plate housing. A floating lower plate is similarly disposed in the lower plate housing and the lower plate is capable of moving within the lower plate housing.

### CROSS-REFERENCE

This application claims the benefit of U.S. Provisional Patent Application No. 62/085,139, filed Nov. 26, 2014. The disclosure of this prior application is incorporated herein by reference in its entirety.

### BACKGROUND

This invention relates to an apparatus used to hold food items for slicing or cutting, and in particular for cutting the food items into pieces of generally equal size. Cutting small foods such as cherry tomatoes or grapes in such a manner can be difficult. One method that is currently used is to place the small food item on a first plate, and then place a second plate on top of the small food item to hold the small food item in the gap between both plates. The user holds the top plate with one hand and uses the other hand to slice the small food item with a knife. It can be difficult to hold the plates in place, and this method can be dangerous. Other known holders do not accommodate foods of different sizes and thicknesses.

### SUMMARY

The food cutting apparatus disclosed herein is intended for use with a kitchen knife or other slicer for slicing food items ranging in size and shape from small, generally spherical items such as grapes or cherry tomatoes, to bulkier and thicker items such as bagels or filets. The apparatus includes two opposing floating plates contained within an upper plate housing and a lower plate housing. The opposing plates are both spring-loaded to permit them to move with respect to one another. The upper plate housing and lower plate housing are connected by a hinge such that the apparatus is capable of holding food centrally to a gap between the two opposing plates. As will be described in greater detail below, when a food item is placed on the lower spring-loaded plate and the upper spring-loaded plate is closed over the food item, the gap formed between the two plates enables a user to use a slicer, such as a knife having an appropriate length, to safely slice the food item, while retaining the food item in the proper location for cutting at a central position. This enables the user to easily and consistently cut the food items into pieces of approximately equal sizes.

A better understanding of the invention will be obtained from the following detailed descriptions and accompanying drawings, which set forth illustrative embodiments that are indicative of the various ways in which the principals of the invention may be employed.

### BRIEF DESCRIPTION OF THE DRAWINGS

FIG. 1 is a perspective view of one embodiment of a food cutting apparatus in a closed position.

FIG. 2 is a further perspective view of the food cutting apparatus of FIG. 1, with the apparatus in an opened position.

FIG. 3 is a further perspective view of the food cutting apparatus of FIG. 1, with the apparatus in an opened position and the upper and lower plates in a compressed position.

FIG. 4 is a rear elevational view of the food cutting apparatus of FIG. 1.

FIG. 5 is a front elevational view of the food cutting apparatus of FIG. 1.

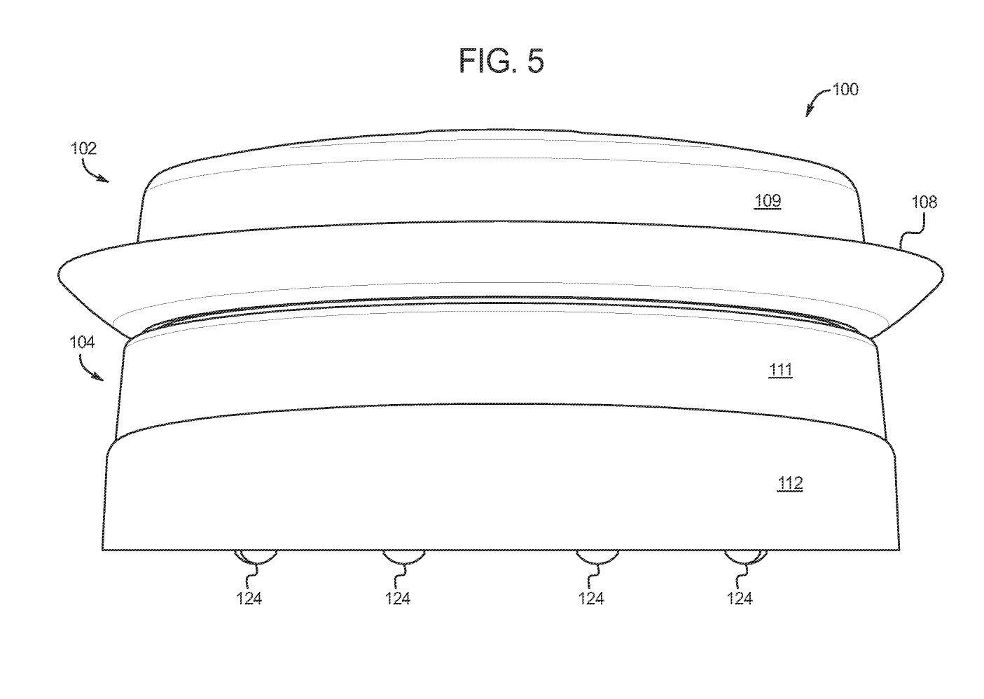

FIG. 6 is a side elevational view of the food cutting apparatus of FIG. 1.

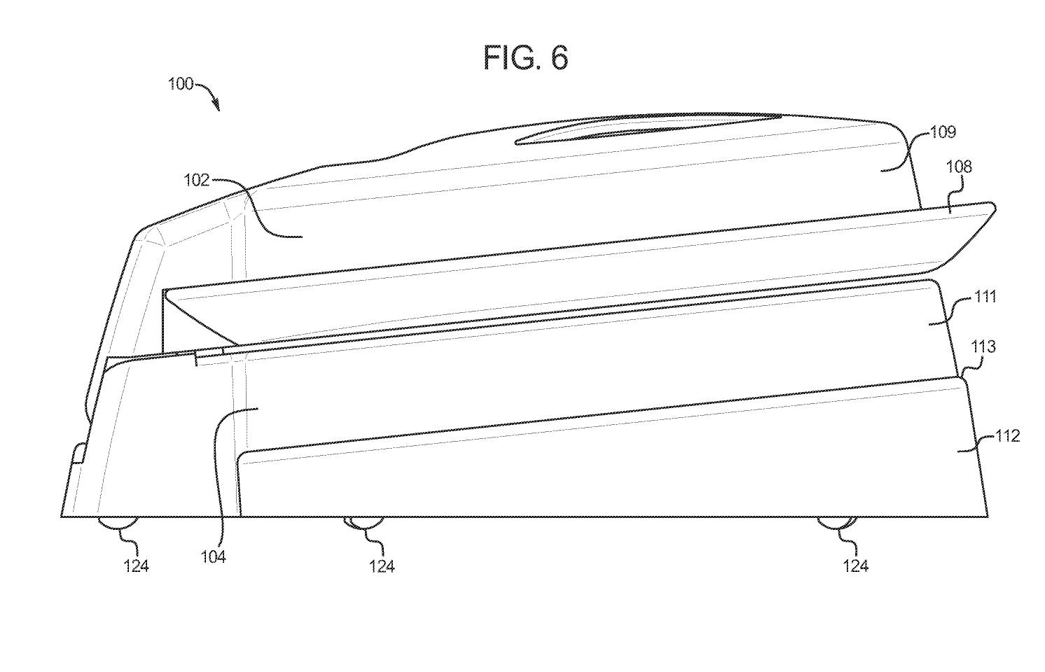

FIG. 7 is a top plan view of the food cutting apparatus assembly of FIG. 1, with certain elements shown in dashed lines to show location.

FIG. 8 is a cross-sectional view of the food cutting apparatus assembly of FIG. 1, along the line 8-8 of FIG. 7.

FIG. 9 is a cross-sectional view similar to FIG. 8, in operation with a plurality of small spherical food items.

FIG. 10 is a bottom plan view of the food cutting apparatus of FIG. 1.

### DETAILED DESCRIPTION OF THE DRAWINGS

The description that follows describes, illustrates and exemplifies one or more embodiments of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers or serial numbers in cases where such labeling facilitates a more clear description. Additionally, the drawings set forth herein are not necessarily drawn to scale, and in some instances proportions may have been exaggerated to more clearly depict certain features. As stated above, this specification is intended to be taken as a whole and interpreted in accordance with the principles of the invention as taught herein and understood by one of ordinary skill in the art.

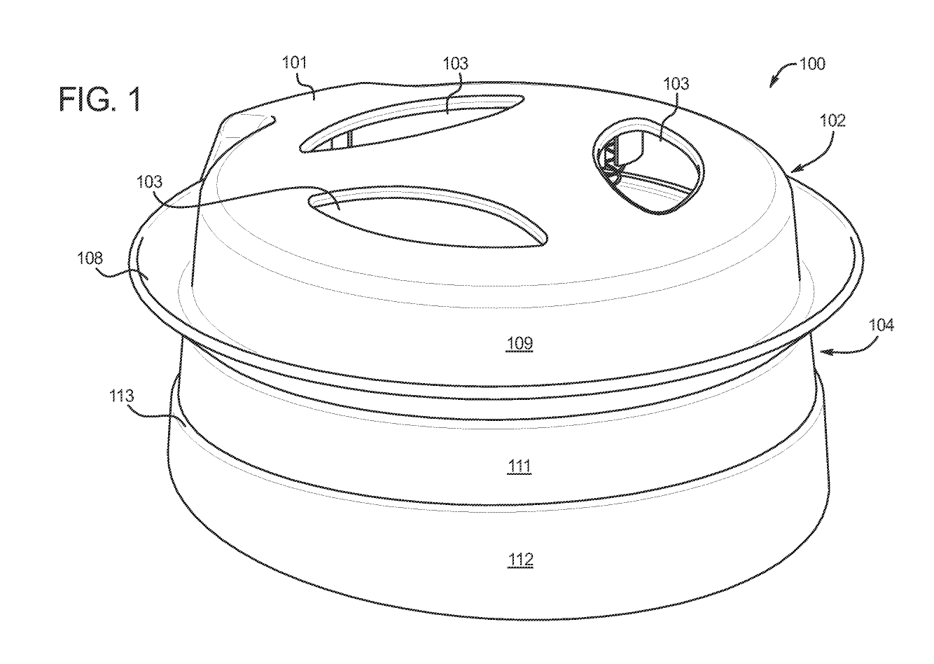

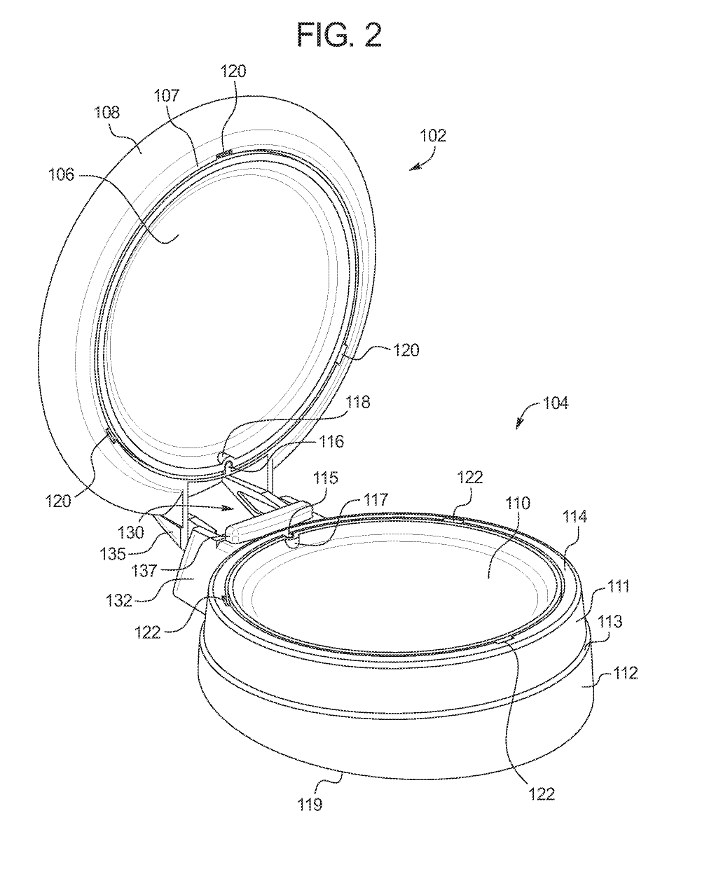

As depicted in FIGS. 1 and 2, the food cutting apparatus 100 comprises an upper plate housing 102 with an upper plate 106 and an opposing lower plate housing 104 with a lower plate 110, and the two housings 102 and 104 are connected by a hinge 130. FIG. 1 depicts the food cutting apparatus 100 in a closed position, where the upper plate housing 102 rests on top of the lower plate housing 104 and the upper plate 106 and the lower plate 110 are not visible. FIG. 2 depicts food cutting apparatus 100 in an open position. In this position, upper plate housing 102 and upper plate 106 are preferably retained at approximately a 90 degree angle from lower plate housing 104 and the lower plate 110, by means of extension 135 interacting with hinge cover 132, to assist in retaining upper plate housing 102 in the open position. In the embodiment depicted, both upper plate housing 102 and lower plate housing 104 have a generally cylindrical shape, and both upper plate 106 and lower plate 110 have a circular shape, although it will be understood that other shapes of these components are within the scope of this disclosure.

As can be seen in FIGS. 1 and 2, the upper plate housing 102 has a top external surface 101 and a sidewall 109 extending downwardly therefrom, and which terminates in a bottom perimeter surface 107. In the depicted embodiment, top external surface 101 of the upper plate housing 102 includes a plurality of internally extending openings 103 that expose the hollow interior of upper plate housing 102. The openings 103 provide for easy gripping of the upper plate housing during and after operation, and permit water to drain from inside upper plate housing 102 during cleaning. Upper plate housing 102 further includes a finger guard 108, which is a lip structure extending around the circumference of the bottom of sidewall 109 to form a safety feature to protect the user's fingers during operation.

The lower plate housing 104 forms the base of the food cutting apparatus 100. In one embodiment, as depicted in FIG. 1, the lower plate housing 104 includes a bottom edge 119 that rests on a table or countertop, and a sidewall extending upwardly therefrom, the sidewall consisting of top section 111 and a bottom section 112 constructed from a single piece of material. In this embodiment, the diameter of the top sidewall section 111 is slightly smaller than the diameter of the bottom sidewall section 112. This difference in diameter creates a ridge 113 along the upper surface of the bottom sidewall section 112. While there is some benefit to having a lower part of the sidewall that has a slightly larger diameter for manufacturing reasons, the appearance of sidewalls 111, 112 and ridge 113 is primarily aesthetic, and apparatus 100 could have a smooth, unbroken sidewall surface.

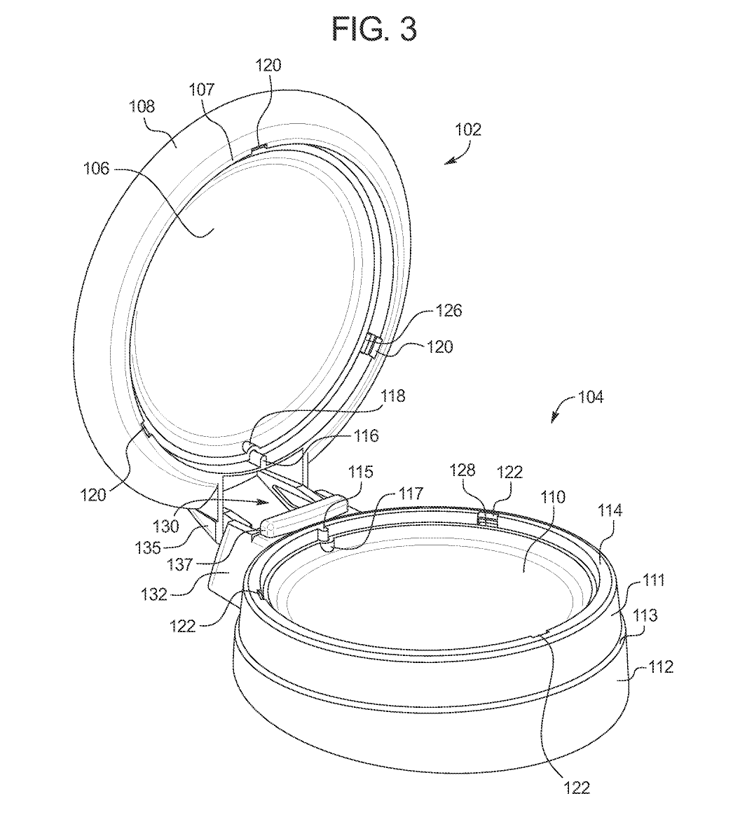

As depicted in FIGS. 2 and 3, when food cutting apparatus 100 is in the open position, the upper plate 106 and lower plate 110 are visible. It will be understood that the view of FIG. 3, where lower plate 110 is partially compressed, is merely for purposes of showing certain features discussed herein, as the lower plate 110 would not be in this position in normal operation when the upper plate housing 102 is open. As noted, in the depicted embodiment, upper plate 106 and lower plate 110 have a generally circular shape. Bottom perimeter surface 107 of upper plate housing 102 forms a perimeter around the upper plate 106, and should sit slightly below the edge of upper plate 106. Similarly, sidewall section 111 terminates at a top perimeter surface 114 which form a perimeter around the lower plate 110, and top perimeter surface 114 should sit above the edge of lower plate 110. When the unit is closed, the bottom perimeter surface 107 and top perimeter surface 114 act as a guide for the knife during the cutting operation, and the aforementioned relationship of these components with their respective plates 106, 110 prevents contact of the knife blade with plates 106, 110.

A notch 115 extends inwardly formed in top perimeter surface 114, and recess 117 is formed in lower plate 110 to fit notch 115. This arrangement prevents lower plate 110 from rotating, and the gap between notch 115 and recess 117 can permit fluid created during the cutting process to drain into lower section 142. A similar notch 116 is formed in bottom perimeter surface 107, and recess 118 is formed in upper plate 106 to fit notch 116 to prevent upper plate 106 from rotating. It should be noted that it is preferred that upper plate 106 be rotated 180 degrees from the position shown in, e.g., FIG. 2, so that the various features described herein are located in a more convenient location for manufacturing purposes.

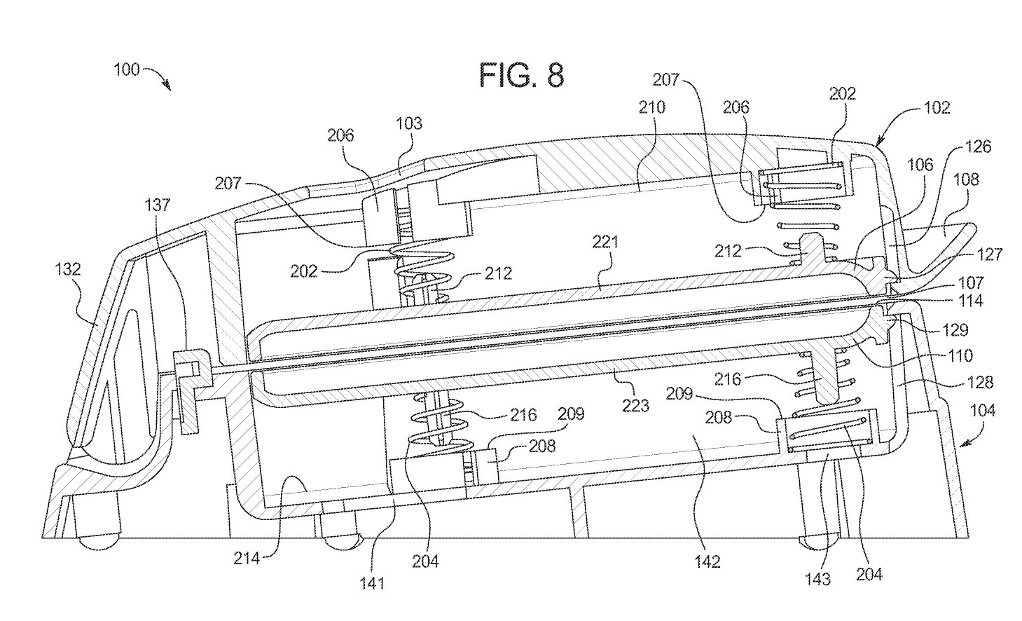

A first plurality of recesses 126 is formed along the perimeter of the upper plate 106 and, as shown most clearly in FIG. 8, a plurality of corresponding tabs 127 extend from upper plate 106 and cooperate with the corresponding recess 126 to limit the motion of upper plate 106 and retain it in the upper plate housing 102. Similarly, a second plurality of recesses 128 is formed along the perimeter of lower plate 110, and a plurality of corresponding tabs 129 extend from lower plate 110 and cooperate with the corresponding recess 128 to limit the motion of lower plate 110 and retain it in the lower plate housing 104. The chamfers 122 assist in assembling the unit.

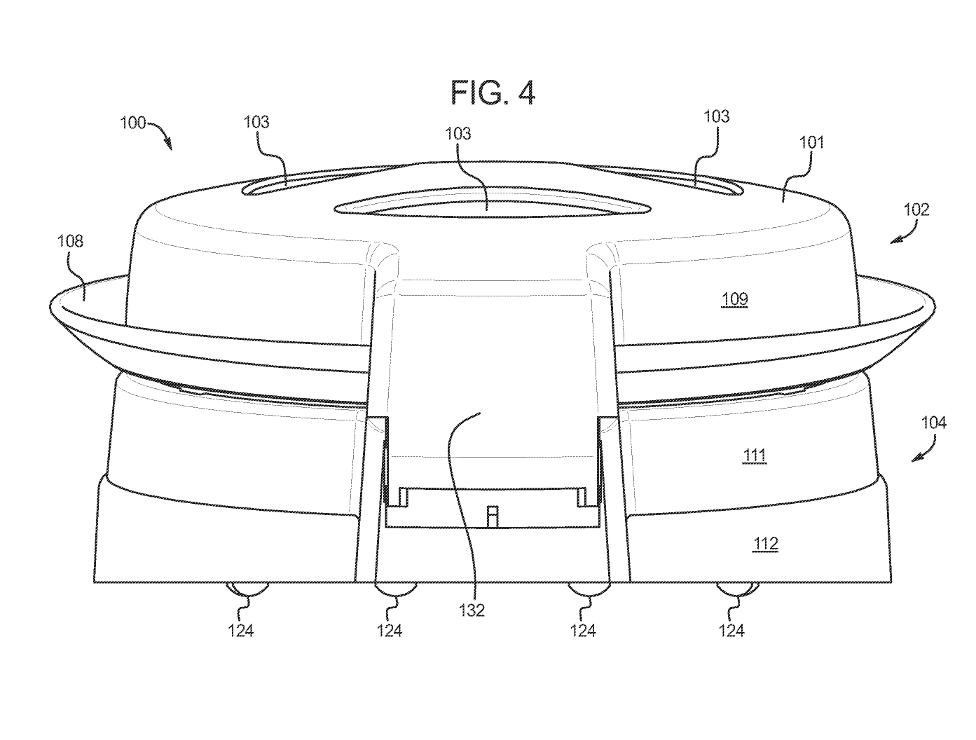

As depicted in FIG. 4, the upper plate housing 102 and the lower plate housing 104 are connected by a fixed hinge 130 which is hidden by a hinge cover 132. The depicted hinge 130 is preferably an all-plastic hinge consisting of a pair of bosses (not shown) on hinge cover 132 of upper plate housing 102, that snap into corresponding circular recesses (not shown) on extension 135. It should be appreciated that other hinge designs that enable the upper plate housing 102 to pivot from the closed position to the open position could also be used.

A plurality of feet 124 may be attached under the bottom of lower plate housing 104. The feet 124 help to prevent scratching a surface with the bottom edge 119 of the bottom sidewall section 112, and they may be constructed of a material that prevents slipping and movement of the food cutting apparatus 100.

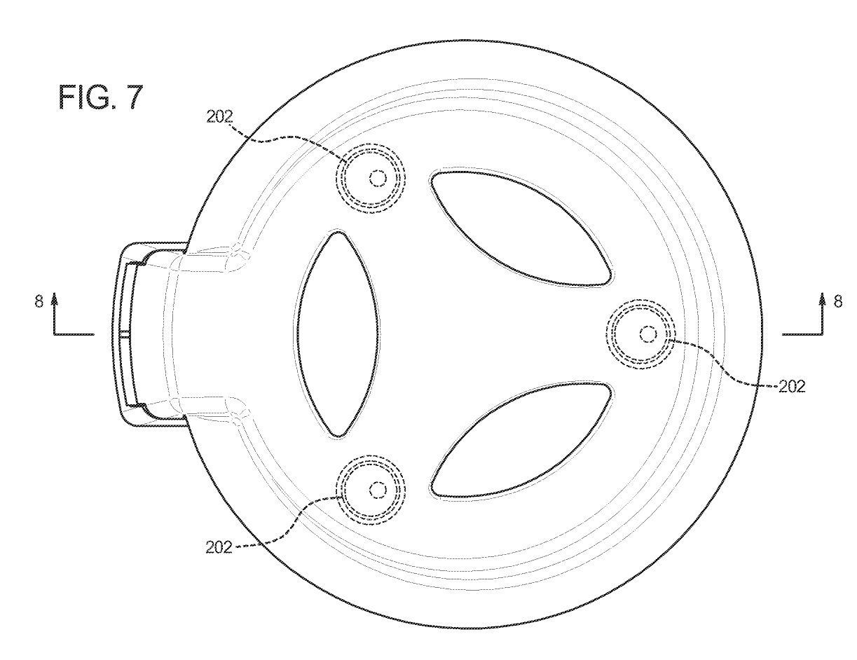

Turning to FIGS. 7 and 8, the upper plate 106 is permitted to “float” inside upper plate housing 102 by means of springs 202, and lower plate 110 similarly “floats” inside lower plate housing 104 by means of springs 204. Springs 202 and 204 are preferably identical in size, construction and spring constant, so that the displacement of the two plates 106, 110 will be essentially equal. The plurality of springs 202 supports upper plate 106 against the interior of upper plate housing 102 so that upper plate 106 is movable within upper plate housing 102. A plurality of spring housings 206 are formed on the inner surface 210 of upper plate housing 102, and a correspondingly aligned plurality of retention pegs 212 extend upwardly from the top surface of upper plate 106, each of the springs 202 are retained by one of the spring housings 206 and one of the retention pegs 212. The range of motion of upper plate 106, and the compression of springs 202, is limited by the bottom surface 207 of each spring housing 206, which contacts top surface 221 of upper plate 106 before springs 202 are fully compressed.

Similarly, a second plurality of springs 204 connect lower plate 110 to the interior of lower plate housing 104 so that lower plate 110 is movable within lower plate housing 104. A plurality of spring housings 208 are formed on the inner surface 214 of lower plate housing 104, and a correspondingly aligned plurality of retention pegs 216 extend from the bottom surface 223 of lower plate 110; each of the springs 204 are retained by one of the spring housings 208 and one of the retention pegs 216. As with the top portion, the range of motion of lower plate 110 is limited by the bottom surface 209 of each spring housing 208, which contacts the bottom surface 223 of lower plate 110 before springs 204 are fully compressed. Retention pegs 216 may be longer than retention pegs 212, since pegs 216 can extend through opening 141. Springs 202, 204 are generally in the non-compressed position prior to use of the apparatus 100.

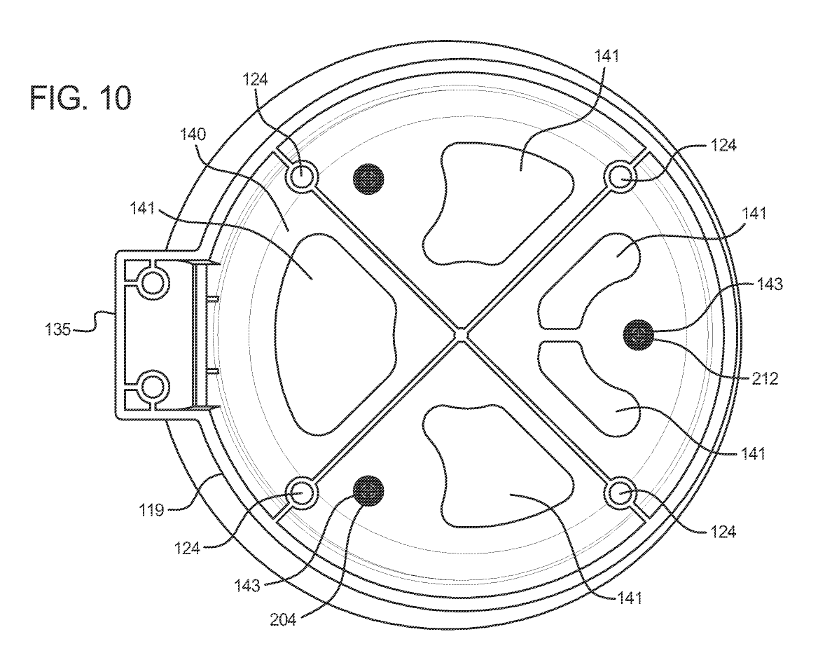

It is preferred that apparatus 100 uses three springs 202 in the upper plate housing 102 and three springs 204 in the lower plate housing 104, and that these two sets of preferably identical springs be located in the same locations in both housings, directly opposite one another, so that the upper plate 106 and lower plate 110 are balanced with respect to one another and the compression of the two plates 106, 110 is equal and consistent. The preferred location of springs 202 is shown in dotted lines in FIG. 7, and the preferred location of springs 204 is shown in the bottom view of FIG. 10.

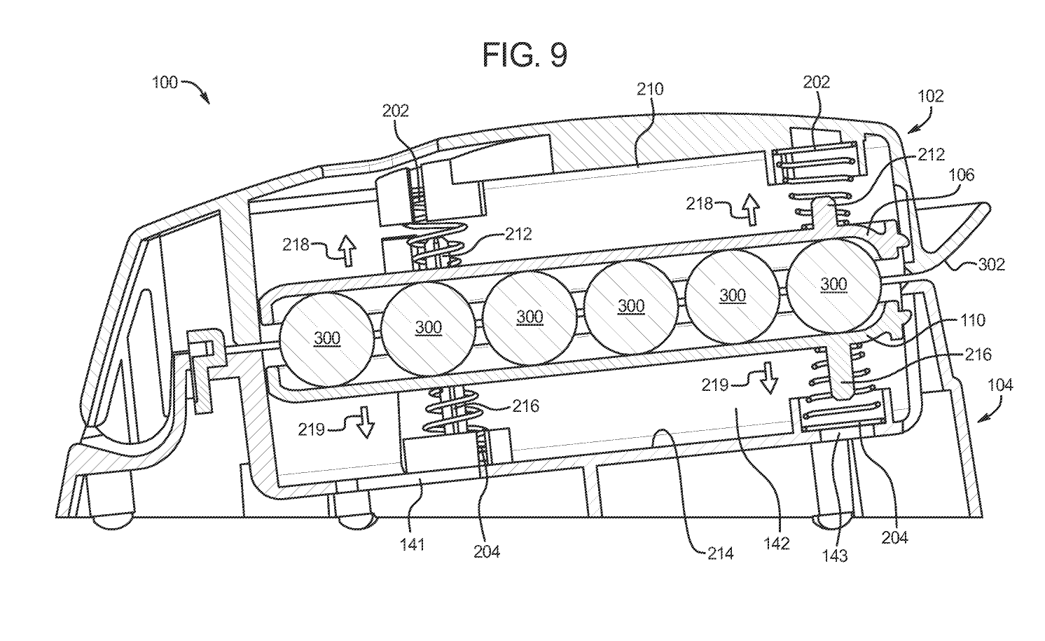

Turning to FIG. 9, in operation, one or more food items 300 are placed on the lower plate 110. Upper plate housing 102 is pivoted down over the food items so that the upper plate 106 is resting on top of the food item(s) 300, closing apparatus 100 so that bottom perimeter surface 107 of upper plate housing 102 is resting on the blade of the knife (not shown). When the upper plate housing 102 is in the closed position over the food items 300, the springs 204 of the lower plate 110 are compressed and the lower plate 110 moves into the lower plate housing 104 in the direction of arrow 219. Simultaneously, the springs 202 of the upper plate 106 are compressed and the upper plate 106 moves into the upper plate housing in the direction of arrow 218. Both sets of springs 202 and 204 are compressed equally so that the food item 300 remains centrally located with respect to the gap 302 between the upper plate housing 102 and the lower plate housing 104. This retains the food items 300 in place by holding them between the upper plate 106 of the upper plate housing 102 and the lower plate 110 of the lower plate housing, and the gap between upper plate housing 102 and lower plate housing 104 will be the same as the thickness of the knife blade.

The knife blade (not shown) is then placed on the front edge of top perimeter surface 114, opposite hinge 130 and preferably adjacent to the closest food item 300 (i.e., to the right in FIG. 9). The plates 106, 110 will be equally compressed, as described above, to ensure that the food items 300 are centered. The user then presses the knife blade against the food items 300 and using a sawing motion, moves the knife blade from the front of the unit toward hinge 130. Knife stop 137 prevents the user from continuing to cut into the hinge 130; when the user reaches the back end of the unit, the blade may be pulled out while the unit is still closed, helping to clean the food off the knife blade. The unit may then be opened and the sliced food pieces removed.

As noted, apparatus 100 may be used with a plurality of smaller items, and the lower plate 110 may be filled with these food items. It is preferred that such smaller food items be roughly all the same size, as the larger items will control the displacement of the plates 106, 110 and smaller items will be cut at an offset. Alternatively, a single larger food item such as a bagel or filet can be placed on lower plate 110, provided that the food item does not extend past the sides of lower plate 110.

The amount of pressure required to be applied in order to close the upper plate housing 102 on the knife blade depends on the size of the food item(s); it is important that the user retain a steady pressure throughout the cutting process so that each food item stays in the same relative location with respect to the other food items, to enable a consistent cut. Given that springs 202 and 204 are preferably identical, the amount of this depression should be equal on both plates 106, 110.

Apparatus 100 is intended for use with a standard kitchen knife, and it should be appreciated that the knife should be long enough so that its tip can be seen when the unit is closed (i.e., it should extend past finger guard 108), so that the back and forth sawing motion does not inadvertently pull the tip entirely into the housing, where it can get caught inside and damage the unit, or at least require the user to start over and risk ruining the cut food items. A knife that is beveled on both sides is preferable, as that style of knife will tend to cut evenly, whereas a knife that has a single beveled edge will tend to cut at a slight angle, thus cutting some of the food items in half, but cutting other food items closer to the back of the unit at an offset.

It should be appreciated that upper plate 106 and lower plate 110 are parallel to one another in the closed position, and are preferably disposed at an angle from the horizontal of approximately six (6) degrees, to make the cutting process easier. Specifically, it has been found that when a plurality of small spherical food items 300 are placed on the lower plate 110, this angle with respect to bottom edge 119 causes the food items 300 to collect near the side of lower plate 110 closest to hinge 130. It is preferred to have these food items 300 collected together so that they remain in place when the knife blade first contacts them, especially when lower plate 110 is only partially filled.

As depicted in FIG. 10, the bottom edge 119 of the bottom sidewall section 112 of the lower plate housing 104 forms the outer perimeter of the bottom base of the apparatus 100. A base surface 140 is depicted as offset from bottom edge 119 and including multiple openings 141 exposing the hollow interior of the lower plate housing 104. The openings 141 permit washing of the interior of the lower plate housing 104. More specifically, during the cutting operation, fluids from the cut foods may drain into section 142, and it is useful to be able to clean this area. The food cutting apparatus 100 is preferably made of plastic and is dishwasher safe. It should be appreciated that the openings 141 are of various size and shape. In this embodiment, three spring openings 143 are depicted. These spring openings 143 are provided for manufacturing reasons.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

We claim:

1. A food cutting apparatus for use with a blade, the apparatus comprising:
a housing comprising an upper plate housing pivotally connected to a lower plate housing, wherein the upper plate housing is capable of being moved from an open position to a closed position where it is adjacent to the lower plate housing, and the lower plate housing comprises a base capable of being supported on a flat surface;
an upper plate disposed in the upper plate housing and capable of moving within the upper plate housing; and
a lower plate disposed in the lower plate housing and capable of moving within the lower plate housing.

2. The food cutting apparatus of claim 1, wherein when a food item is placed on the lower plate and the upper plate housing is moved into the closed position, the upper plate moves the same distance into the upper plate housing as the lower plate moves into the lower plate housing such that the food item is centered between the upper plate housing and the lower plate housing with respect to a gap formed between the upper plate housing and the lower plate housing.

3. The food cutting apparatus of claim 1, further comprising a finger guard disposed around a perimeter of the upper plate housing.

4. The food cutting apparatus of claim 1, further comprising a plurality of recesses at the top of the upper plate housing.

5. The food cutting apparatus of claim 1, wherein:
the lower plate housing further comprises a lower sidewall extending upwardly from the base, the lower sidewall terminating in a top perimeter surface; and
the upper plate housing further comprises a top wall and an upper sidewall extending downwardly from the top wall and terminating in a lower perimeter surface that is generally parallel to the top perimeter surface of the lower plate housing when the housing is in the closed position;
wherein the blade being disposed between the top perimeter surface and the lower perimeter surface forms a gap between the upper plate and the lower plate when the housing is in the closed position, and a food item will be centered between the upper plate and the lower plate.

6. The food cutting apparatus of claim 5, wherein the top perimeter surface and the lower plate are sloped at a predetermined angle with respect to the base.

7. The food cutting apparatus of claim 6, wherein the predetermined angle equals approximately six degrees.

8. The food cutting apparatus of claim 5, further comprising a first plurality of springs disposed in the upper plate housing and contacting an inner surface of the upper plate to permit the upper plate to float in the upper plate housing, and a second plurality of springs disposed in the lower plate housing and contacting an inner surface of the lower plate to permit the lower plate to float in the lower plate housing.

9. The food cutting apparatus of claim 8, wherein each of the first plurality of springs are identical in construction to each of the second plurality of springs.

10. The food cutting apparatus of claim 9, wherein the first plurality of springs and the second plurality of springs each consist of three springs.

11. The food cutting apparatus of claim 10, wherein each of the first plurality of springs are located directly opposite a corresponding one of the second plurality of springs when the upper plate housing is in the closed position.

12. The food cutting apparatus of claim 1, further comprising a hinge connecting the upper plate housing to the lower plate housing, and the upper plate housing is disposed generally perpendicular to the flat surface when the upper plate housing is in the open position.

13. A food cutting apparatus for use with a blade, the apparatus comprising:
an upper plate housing comprising an upper plate supported by a first plurality of springs, the upper plate disposed in the upper plate housing and capable of moving within the upper plate housing; and
a lower plate housing comprising a lower plate supported by a second plurality of springs, the lower plate disposed in the lower plate housing and capable of moving within the lower plate housing, and the lower plate housing comprising a base capable of being supported on a flat surface;
wherein the upper plate housing is pivotally connected to the lower plate housing, and the upper plate housing is capable of being moved from an open position to a closed position where the upper plate housing is adjacent to the lower plate housing; and
wherein when the upper plate housing is in the closed position, a gap formed between the upper plate housing and the lower plate housing is capable of receiving the blade to slice a food item, while retaining the food item between the upper plate and the lower plate.

14. The food cutting apparatus of claim 13, wherein when the food item is placed on the lower plate and the upper plate housing is moved into the closed position, the upper plate moves the same distance into the upper plate housing as the lower plate moves into the lower plate housing such that the food item is centered between the upper plate housing and the lower plate housing with respect to the gap.

15. The food cutting apparatus of claim 13, further comprising a finger guard disposed around a perimeter of the upper plate housing.

16. The food cutting apparatus of claim 13, wherein the lower plate housing further comprises a lower sidewall extending upwardly from the base, the lower sidewall terminating in an top perimeter surface, wherein the top perimeter surface and the lower plate are sloped at a predetermined angle with respect to the base.

17. The food cutting apparatus of claim 16, wherein the predetermined angle equals approximately six degrees.

18. The food cutting apparatus of claim 13, wherein:
the lower plate housing further comprises a lower sidewall extending upwardly from the base, the lower sidewall terminating in an top perimeter surface; and
the upper plate housing further comprises a top wall and an upper sidewall extending downwardly from the top wall and terminating in a lower perimeter surface that is generally parallel to the top perimeter surface of the lower plate housing when the upper plate housing is in the closed position.

19. The food cutting apparatus of claim 18, wherein the top perimeter surface and the lower plate are sloped at a predetermined angle with respect to the base.

20. The food cutting apparatus of claim 13, wherein the first plurality of springs supporting the upper plate in the upper plate housing contact an inner surface of the upper plate to permit the upper plate to float in the upper plate housing, and the second plurality of springs supporting the lower plate in the lower plate housing contact an inner surface of the lower plate to permit the lower plate to float in the lower plate housing.

21. The food cutting apparatus of claim 20, wherein each of the first plurality of springs is located directly opposite a corresponding one of the second plurality of springs when the upper plate housing is in the closed position, and each of the first plurality of springs is identical in construction to each of the second plurality of springs.

22. A food cutting apparatus comprising:
a housing comprising an upper plate housing pivotally connected to a lower plate housing, and the lower plate housing comprising a base capable of being supported on a flat surface;
an upper plate supported by at least one first spring, the upper plate disposed in the upper plate housing and capable of moving within the upper plate housing; and
a lower plate supported by at least one second spring, the lower plate disposed in the lower plate housing and capable of moving within the lower plate housing,
wherein when a food item is placed on the lower plate and the upper plate housing is moved from an open position to a closed position over the food item, the upper plate moves a same distance into the upper plate housing as the lower plate moves into the lower plate housing such that the food item is centered within the upper plate housing at a central position, and;
wherein when the upper plate housing is in the closed position, a gap is formed between the upper plate housing and the lower plate housing, while retaining the food item between the upper plate and the lower plate at the central position.

23. The food cutting apparatus of claim 22, further comprising a finger guard disposed around a perimeter of the upper plate housing.

24. The food cutting apparatus of claim 22, wherein:
the lower plate housing further comprises a lower sidewall extending upwardly from the base, the lower sidewall terminating in an top perimeter surface; and
the upper plate housing further comprises a top wall and an upper sidewall extending downwardly from the top wall and terminating in a lower perimeter surface that is generally parallel to the top perimeter surface of the lower plate housing when the housing is in the closed position.
